(19) United States
(12) Patent Application Publication
(10) Pub. No.: US 2025/0228302 A1
(43) Pub. Date: Jul. 17, 2025

(54) MODULE FOR WIRELESS COMMUNICATION AND AEROSOL GENERATION

(71) Applicant: KT&G CORPORATION, Daejeon (KR)

(72) Inventors: Won Kyung LEE, Gyeonggi-do (KR); Jang Heun YEUM, Seoul (KR)

(73) Assignee: KT&G CORPORATION, Daejeon (KR)

(21) Appl. No.: 18/992,798

(22) PCT Filed: Nov. 1, 2023
(86) PCT No.: PCT/KR2023/017319

§ 371 Date: Jan. 9, 2025

(30) Foreign Application Priority Data
Nov. 8, 2022 (KR) 10-2022-0147783

(51) Int. Cl. A24F 40/65; A24F 40/465; A24F 40/57; H01Q 1/22; H01Q 9/04; H05B 6/02

(52) U.S. Cl. CPC A24F 40/65; A24F 40/465; A24F 40/57; H01Q 1/22; H01Q 9/0407; H05B 6/02

(57) ABSTRACT

A module for wireless communication and aerosol generation (or a communication and aerosol device) that includes a mounting part having a mounting body shaped to define an accommodation space that is sized to receive an article having an aerosol generating material, where the mounting body includes a dielectric. An inlet is formed at an end of the mounting body, which permits the article to be received by the accommodation space, and a heating part is used to heat the aerosol generating material when at least a portion of the article is positioned within the accommodation space. The module further includes an antenna having a patch coupled to the mounting body, and is located outside the accommodation space. The patch includes a conductor. The antenna also includes a ground coupled to the mounting body, is located outside the accommodation space, and is spaced at a distance from the patch. The ground includes a conductor.

### TECHNICAL FIELD

The present application relates to a communication and aerosol module implementing a wireless communication function and an aerosol generation function, and to a communication terminal having the module.

### BACKGROUND ART

An aerosol generator is a device that enables a user to inhale an aerosol by heating an aerosol generating substance stored inside an aerosol generating article.

One of the conventional aerosol generators is provided in a communication terminal such as a cell phone (U.S. Pat. No. 9,894,938). The aerosol generator provided in the communication terminal is supplied with power through a power supply (such as a battery) provided inside the communication terminal to heat the aerosol generating material.

Conventional devices in which an aerosol generator and a communication terminal are integrated have only disclosed the concept of sharing a power supply by the aerosol generator and the communication terminal, but have not provided structural and functional solutions for the characteristics of the aerosol generator and the communication terminal and for easy coupling of the aerosol generator and the communication terminal, necessary to implement a device in which the aerosol generator and the communication terminal are integrated.

### DISCLOSURE

### Technical Problem

A feature of the present disclosure is to provide a communication and aerosol module capable of implementing both a wireless communication function and an aerosol generation function.

Another feature of the present disclosure is to provide a communication and aerosol module capable of implementing a wireless communication function and an aerosol generation function, and having a structure applicable to various communication terminals.

Another feature of the present disclosure is to provide a communication and aerosol module capable of selecting an antenna to perform a wireless communication function among multiple antennas depending on whether the aerosol generation function is performed.

### Technical Solution

In one aspect of the present disclosure, provided herein is a module for wireless communication and aerosol generation (or a communication and aerosol device), including a mounting part including a mounting body having an accommodation space for accommodation of an article containing an aerosol generating material, the mounting body being formed of a dielectric, and an inlet connected to the accommodation space through one surface of the mounting body to allow the article to be inserted into, a heating part configured to heat the aerosol generating material inserted in the accommodation space, and an antenna including a patch fixed to the mounting body and disposed outside the accommodation space, the patch being formed of a conductor, and a ground fixed to the mounting body and disposed outside the accommodation space at a point spaced apart from the patch, the ground being formed of a conductor.

The mounting body may be formed in a cylindrical shape, wherein the patch and the ground may be arranged to be spaced apart from each other along a circumferential direction of the mounting body or along a height direction of the mounting body.

The mounting body may be formed in a prismatic shape, wherein the patch and the ground may be arranged to be spaced apart from each other along a perimeter direction of the mounting body or along a height direction of the mounting body.

The module may further include an extension body protruding from the mounting body so as to be positioned outside the accommodation space, the extension body being formed of a dielectric having a shape of a flat plate, wherein the patch and the ground may be fixed to the extension body.

The module may further include an extension body protruding from the mounting body so as to be positioned outside the accommodation space, the extension body being formed of a dielectric, wherein one of the patch and the ground may be fixed to the mounting body, and the other of the patch and the ground may be fixed to the extension body.

The module may further include a communicator configured to feed the patch, and a controller configured to control operation of the heating part.

The heating part may include a coil provided inside the mounting body to surround the accommodation space for induction heating of a conductor disposed inside the aerosol generating material.

The heating part may include a heater formed in a bar shape or a plate shape, the heater being fixed to the mounting body and disposed inside the accommodation space, wherein, when the article is inserted into the accommodation space, the heater may contact the aerosol generating material through a bottom surface of the article.

The heating part may include a heater formed in a pipe shape and disposed inside the accommodation space, the heater surrounding a circumferential surface of the article inserted in the accommodation space.

In another aspect of the present disclosure, provided herein is a module for wireless communication and aerosol generation, including a mounting part including a mounting body having an accommodation space for an article containing an aerosol generating material, the mounting body being formed of a dielectric, and an inlet connected to the accommodation space through one surface of the mounting body to allow the article to be inserted into, a heating part configured to heat the aerosol generating material inserted in the accommodation space, a first antenna including a first patch fixed to the mounting body and disposed outside the accommodation space, the patch being formed of a conductor, and a first ground fixed to the mounting body and disposed outside the accommodation space at a point spaced apart from the first patch, the ground being formed of a conductor, a second antenna including a dielectric body formed of a dielectric and disposed at a point separated from the mounting body, a second patch formed of a conductor and fixed to the dielectric body, and a second ground formed of a conductor and fixed to the dielectric body, the second ground being disposed at a point separated from the second patch, a communicator configured to control feeding of the first patch and the second patch, a first circuit connecting the first patch and the communicator, a second circuit connecting the second patch and the communicator, and a switch configured to control opening and closing of the first circuit and the second circuit.

When the article is inserted into the accommodation space, the switch may close the second circuit and open the first circuit.

When the article is not inserted into the accommodation space, the switch may close the first circuit and open the second circuit.

The mounting body may be formed in a cylindrical shape, wherein the first patch and the first ground may be arranged to be spaced apart from each other along a circumferential direction of the mounting body or along a height direction of the mounting body.

The module may further include an extension body protruding from the mounting body so as to be positioned outside the accommodation space, the extension body being formed of a dielectric having a shape of a flat plate, wherein the first patch and the first ground may be fixed to the extension body.

### Advantageous Effects

The present disclosure provides a communication and aerosol module capable of implementing both a wireless communication function and an aerosol generation function.

Further, the present disclosure provides a communication and aerosol module capable of implementing both a wireless communication function and an aerosol generation function, and having a structure applicable to various communication terminals.

Furthermore, the present disclosure provides a communication and aerosol module that capable of selecting an antenna to perform a wireless communication function among multiple antennas depending on whether the aerosol generation function is performed.

### DESCRIPTION OF DRAWINGS

FIG. 1 illustrates a first embodiment of a communication and aerosol module.

FIGS. 2-(a) and 2-(b) are cross-sectional views of the communication and aerosol module.

FIGS. 3-(a), 3-(b), and 3-(c) illustrate examples of heating elements provided in the communication and aerosol module.

FIG. 4 illustrates a second embodiment of a communication and aerosol module.

FIGS. 5-(a), 5-(b), and 5-(c) illustrate a third embodiment of a communication and aerosol module.

FIGS. 6-(a) and 6-(b) illustrate a fourth embodiment of a communication and aerosol module.

FIGS. 7, 8-(a), and 8-(b) illustrate a fifth embodiment of a communication and aerosol module.

FIGS. 9 and 10 illustrate embodiments of a communication terminal having a communication and aerosol module.

### BEST MODEL

Hereinafter, preferred embodiments of a communication and aerosol module, and a communication terminal having the module, will be described with reference to the accompanying drawings.

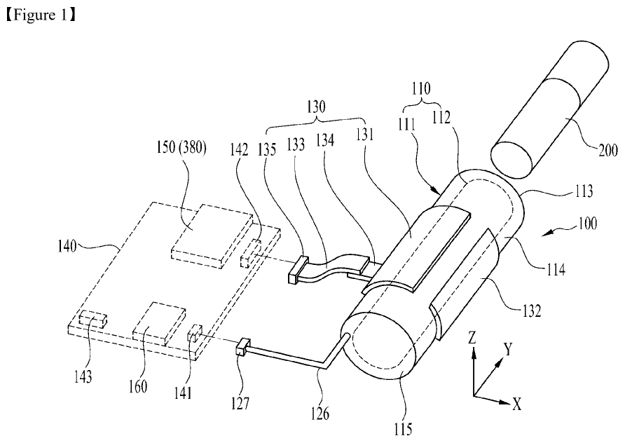

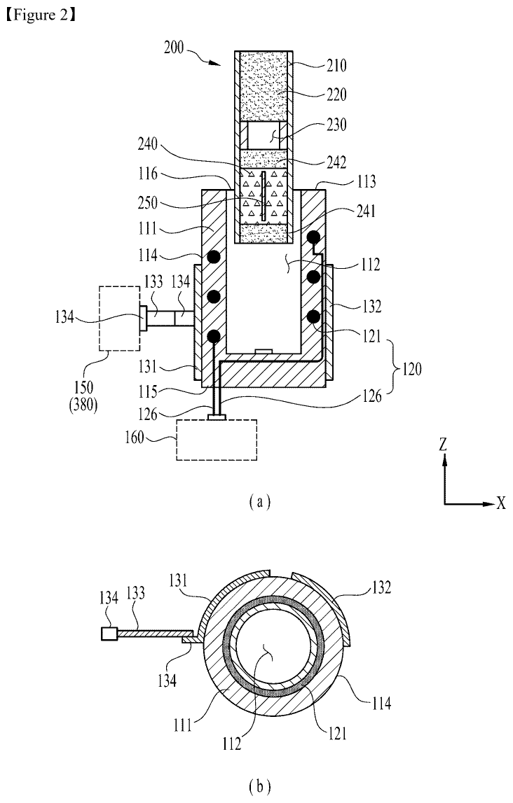

FIG. 1 illustrates an example of a communication and aerosol module (or communication and aerosol generation device) 100. The module 100 may include a mounting part 110 to which an aerosol generating article (hereinafter referred to as “article”) 200 is removably coupled, a heating part 120 (FIG. 2) configured to provide thermal energy to the article coupled to the mounting part 110, and an antenna 130 (first antenna) configured to enable transmission and reception of wireless signals to and from external devices.

As shown in FIG. 2, the article (e.g., a “stick”) 200 includes an article body 210 defining an outer appearance, a filter 220 disposed inside the article body 210, and an aerosol generating material 240 (hereinafter “medium”) disposed inside the article body 210.

The filter 220 may be positioned outside the mounting part 110 when the article body 210 is coupled to the mounting part 110. The medium 240 may be positioned inside the mounting part 110 when the article body 210 is coupled to the mounting part 110.

The medium 240 is a material that releases volatile compounds that can form an aerosol when supplied with thermal energy, and may be a liquid or a granular solid. The medium 240 may contain tobacco (a plant material), nicotine, and other volatile flavor compounds. The medium 240 may include a plurality of granules, wherein the granules may have a size from 0.4 mm to 112 mm.

A cooling part 230 may be arranged between the filter 220 and the medium 240. The cooling part 230 may have a hollow cylinder shape. Furthermore, to prevent the medium 240 from being discharged from the article body 210, and from being discharged into the cooling part 230, a first cover 241 may be provided on the bottom surface of the article body 210, and a second cover 242 may be provided between the medium 240 and the cooling part 230.

The first cover 241 and the second cover 242 may be formed of a porous material that allows the movement of air but prevents the discharge of the medium 240, and the article body 210 may be formed of a material (such as paper) that surrounds the first cover 241, medium 240, second cover 242, cooling part 230, and filter 220.

As shown in FIGS. 2-(a) and 2-(b), the mounting part 110 may include a mounting body 111 having an accommodation space 112 for the medium 240. The mounting body 111 may be formed in the shape of a cylinder having the accommodation space 112 formed therein, and may be formed of a dielectric material.

The dielectric material may be a polyester-based resin, a cellulose-based resin, a polycarbonate-based resin, an acrylic-based resin, a styrene-based resin, a polyolefin-based resin, a vinyl chloride-based resin, an amide-based resin, an imide-based resin, a polyethersulfone-based resin, a sulfone-based resin, a polyetheretherketone-based resin, a polyphenylene sulfide-based resin, a vinyl alcohol-based resin, a vinylidene chloride-based resin, a vinylbutyral-based resin, an allylate-based resin, a polyoxymethylene-based resin, an epoxy-based resin, a thermoplastic resin, or the like. The mounting body 110 may be made of any one of the above-mentioned materials, or a combination of two or more thereof.

A top surface 113 of the mounting body may be provided with an inlet 116 for entry and exit of the article body 210, and the antenna 130 may be fixed to a circumferential surface 114 of the mounting body. Also, a heating part wire 126 for control of the heating part 120 may be fixed to a bottom surface 115 of the mounting body.

The heating part 120 may be provided with a heat source of an internal heating type that supplies thermal energy from the inside the article body 210, or may be provided with a heat source of an external heating type that supplies thermal energy from the outside the article body 210.

FIG. 2-(a) illustrates an example of the internal heating type heating part. According to this embodiment, the heating part 120 may include a coil 121 that inductively heats a conductor (e.g., a metal plate) 250 disposed inside the medium 240.

In this case, the coil 121 may be arranged inside the mounting body 111 to enclose the accommodation space 112. In other words, the coil 121 may be wound along a height direction (Y-axis direction) of the mounting body to enclose or otherwise surround at least a portion of the accommodation space 112.

The coil 121 may be configured to receive power via the heating part wire 126. FIG. 2-(a) illustrates an example where the heating part wire 126 is connected to the coil 121 through the bottom surface 115 of the mounting body.

When current is supplied to the coil 121 via the heating part wire 126, the conductor 250 disposed inside the medium 240 is heated. Accordingly, when a user inhales external air through the filter 220, the aerosol generated in the medium 240 will be supplied to the user through the filter 220.

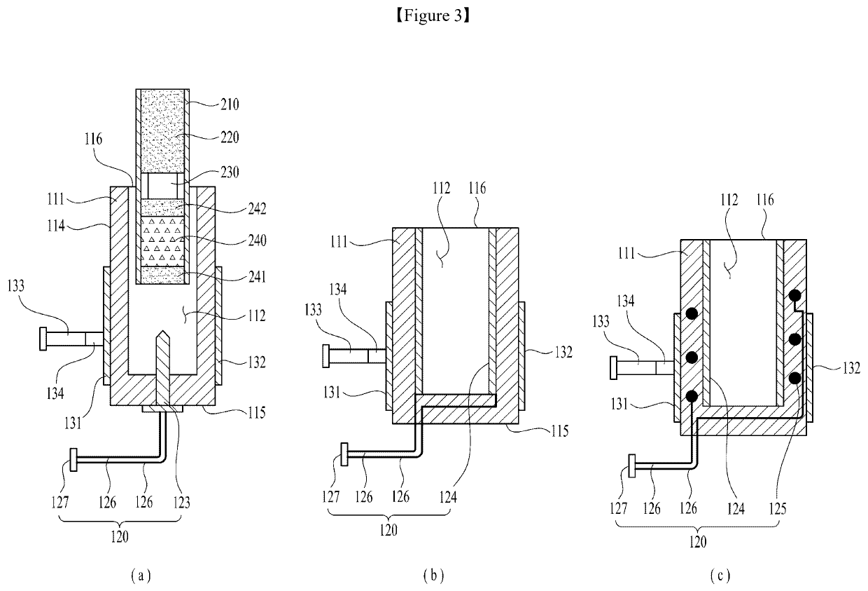

FIG. 3-(a) illustrates another embodiment of the internal heating type heater. According to this embodiment, the heating part 120 may include a heater 123 that contacts the medium 240 through the article body 210 when the article body 210 is inserted into the accommodation space 112.

According to this embodiment, the heater 123 may be a metal in the form of a bar or a plate fixed to the bottom surface 115 of the mounting body and positioned inside the accommodation space 112. In this case, when the article body 210 is inserted into the accommodation space 112, the free end of the heater 123 will be disposed inside the medium 240 through the first cover 241 (the bottom surface of the article body).

FIGS. 3-(b) and 3-(c) illustrate embodiments of heating parts of an indirect heating type. The heating parts of FIGS. 3-(b) and 3-(c) are identical in that they include a pipe-shaped heater 124 that surrounds the circumferential surface of the article body 210 inserted into the accommodation space 112. The pipe-shaped heater 124 may be fixed to the mounting body 111 and is positioned inside the accommodation space 112. While the heater 124 of FIG. 3-(b) is supplied with power via the heater wire 126, the heater 124 of FIG. 3-(c) is heated via the coil 125 positioned inside the mounting body 111.

As shown in FIG. 1, the antenna 130 may include a patch (a first patch) 131 fixed to the mounting body 111 and disposed outside the accommodation space 112, and a ground (a first ground) 132 fixed to the mounting body 111 and disposed outside the accommodation space 112. The patch 131 and the ground 132 may be formed of a conductor, such as a metal plate, and may be fixed to the mounting body 111 and disposed at positions separated from each other.

The antenna 130 may be supplied with current through a feeding line (a first feeding line) 134, which is connected to the patch 131, and an antenna wire 133, connects the feeding line 134 to a communicator 150. The feeding term refers to the operation of applying current to the patch 131.

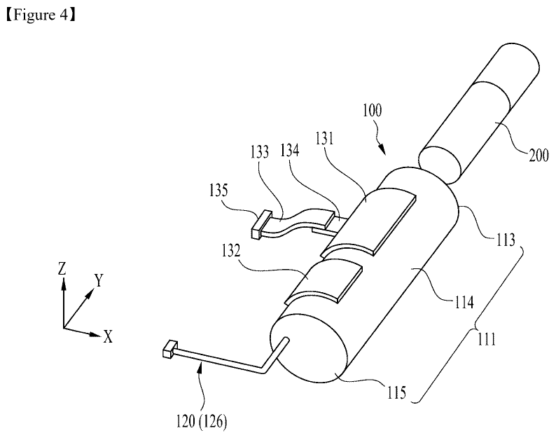

For setting the radiation direction of the antenna 130, the patch 131 and ground 132 may be arranged in various ways. Specifically, when the mounting body 111 is formed in a cylindrical shape, the patch 131 and the ground 132 may be arranged to be spaced apart from each other along a circumferential direction of the mounting body 111 (FIG. 1), or may be arranged to be spaced apart from each other along the height direction (Y-axis direction) of the mounting body 111 (FIG. 4).

As shown in the figures, the mounting body 111 may be formed in a prismatic shape. In this case, the patch 131 and the ground 132 may be arranged to be spaced apart from each other along the direction of the perimeter of the mounting body 111, or may be arranged to be spaced apart from each other along the height direction of the mounting body 111.

The shape of the patch 131, the size and thickness of the patch 131, the spacing between the patch 131 and the ground 132, the material and thickness of the mounting body 111, which is a dielectric, and the like should be set according to the desired frequency band for transmission and reception.

In the case where the mounting body 111 is formed in a cylindrical shape and in the case where the mounting body 111 is formed in a prismatic shape, the patch 131 and the ground 132 fixed on the outer peripheral surface of the mounting body 111 will have a curved shape.

For instance, as shown in FIG. 2-(b), the patch 131 and the ground 132 have a curved shape according to the shape of the cross section of the mounting body 111. Such a shape of the patch and ground may increase the transmission and reception efficiency in some cases (depending on the set frequency band for transmission and reception).

The communication and aerosol module 100 having the above-described structure may be provided in a communication terminal having a communicator and a power supply unit, thereby implementing a wireless communication function and an aerosol generation function.

In order to secure compatibility of the module 100 with a communication terminal, the heating part wire 126 may be provided with a heating part connector 127 removably connected to a circuit (substrate, etc.) of the communication terminal, and the antenna wire 133 may be provided with an antenna connector (first antenna connector) 135 removably connected to the circuit (substrate, etc.) of the communication terminal.

Further, as shown in FIG. 1, the module 100 may further include a controller 160 configured to control operation of the heating part 120 (FIG. 2-(a)), and a communicator 150 configured to control wireless communication through the antenna 130.

The controller 160 (which may be implemented using one or more processors) may be configured as a device or circuit to control power supplied to the coils 121 and 125 or the heaters 123 and 124 via the heating part wire 126, and the communicator (communication module or communication circuit) 150 may be configured as a device to implement a wireless communication function adapted to the purpose of the communication terminal to which the module 100 is to be mounted.

To ensure compatibility of the communication and aerosol module 100 provided with the controller 160 and communicator 150, the module 100 may further include a PCB 140 on which the controller and communicator are fixed.

The PCB 140 may be provided with a first connector 141 to which the heating part connector 127 is connected, a second connector 142 to which the antenna connector 135 is connected, and a third connector 143 to which the controller (terminal controller or application processor) of the communication terminal is connected.

Thus, the present disclosure can provide a communication and aerosol module that is capable of realizing both the wireless communication function and the aerosol generation function, and is applicable to various communication terminals.

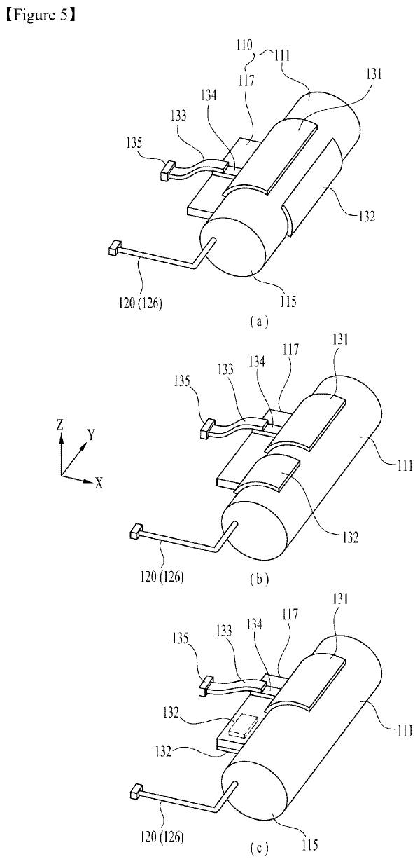

FIGS. 5-(a), 5-(b), and 5-(c) illustrate other embodiments of the module 100.

The communication and aerosol module 100 according to this embodiment differs from the embodiments of FIGS. 1 to 4 in that it further includes an extension body 117 extending from the mounting body 111.

The extension body 117 may be a plate projecting from the circumferential surface of the mounting body 111 along a diameter direction (X-axis direction) of the mounting body. The extension body 117 may be provided with, or otherwise include, a dielectric, which may be the same dielectric as the mounting body 111, or may be a different dielectric than the mounting body 111.

When the extension body 117 is provided, the feeding line 134 provided to the patch 131 may be provided to the extension body 117. The antenna wire 133 may be connected (e.g., coupled) to the feeding line 134 by bonding. In this case, the extension body 117 may improve the durability of the module 100 by maintaining a stable coupling between the antenna wire 133 and the feeding line 134.

FIG. 5-(a) illustrates a case where the patch 131 and the ground 132 are spaced apart from each other along the outer circumferential surface of the mounting body 111, and FIG. 5-(b) illustrates a case where the patch 131 and the ground 132 are spaced apart from each other along a height direction (Y-axis direction) of the mounting body 111.

As shown in FIG. 5-(c), the patch 131 may be fixed to the circumferential surface of the mounting body 111, the feeding line 134 may be fixed to the top surface of the extension body 117, and the ground 132 may be fixed to the bottom surface of the extension body 117 (opposite to the surface on which the feeding line is fixed).

If necessary or otherwise desired for setting the radiation direction of the antenna 130, the module 100 of FIG. 5-(c) may be alternatively configured such that the ground 132 is fixed on the same surface as the surface on which the feeding line 134 is disposed. In this example of FIG. 5-(c), the ground 132 is shown in dotted line. To be clear, the example of FIG. 5-(c) depicts two alternative arrangements; one being the positioning of the ground 132 on a side of the extension body 117 that is opposite that of the feeding line 134, and the other being the positioning of ground 132 (shown in dashed lines) on the same (e.g., top) side of the extension body as the feeding line 134. As a further alternative to that shown in FIG. 5-(c), the patch 131 may be alternatively fixed to the extension body 117, and the ground 132 may be fixed to the mounting body 111.

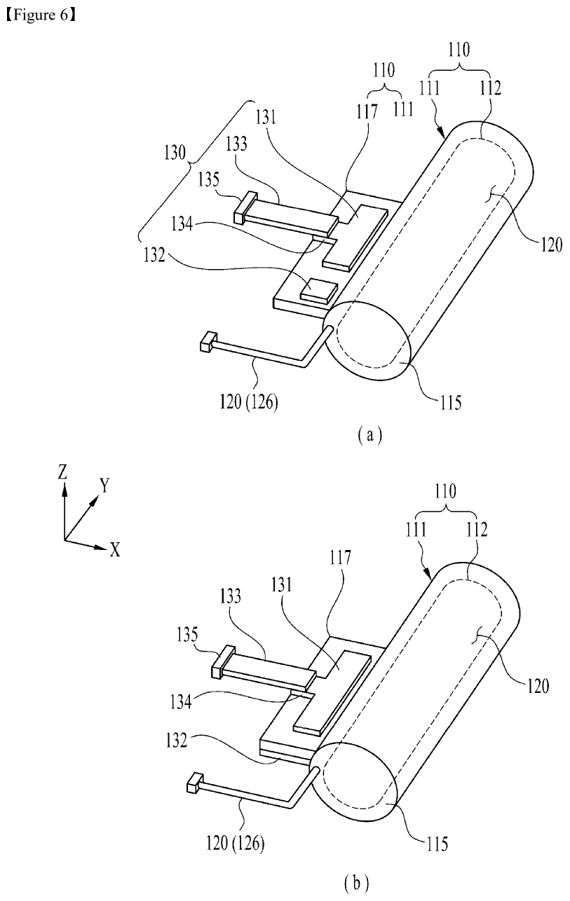

FIG. 6 illustrates another embodiment of the module 100. In the module 100 according to this embodiment, both the patch 131 and the ground 132 are fixed to the extension body 117.

As shown in FIG. 6-(a), the patch 131 and the ground 132 may be fixed to the extension body 117 such that they are spaced apart from each other along the height direction (Y-axis direction) of the mounting body. The patch 131 and the ground 132 may be provided in the same plane in the space provided by the extension body 117. The figure illustrates an exemplary case where the patch and the ground are fixed to the top surface of the extension body 117. In contrast with the case illustrated in FIG. 6-(a), the patch 131 and the ground 132 may be alternatively fixed to the extension body 117 so that they are spaced apart from each other along the diameter direction (X-axis direction) of the mounting body.

FIG. 6-(b) illustrates an embodiment in which one of the patch 131 and the ground 132 is fixed to the top surface of the extension body 117, and the other of the patch and the ground is fixed to the bottom surface of the extension body 117.

With the above-described structure of the communication and aerosol module 100, when the article 200 is inserted into the accommodation space 112, the dielectric permittivity of the mounting part 110 may change, resulting in a degradation of the functionality set for the antenna 130.

In order to address the above-mentioned issue, the module 100 may to further include a second antenna 170.

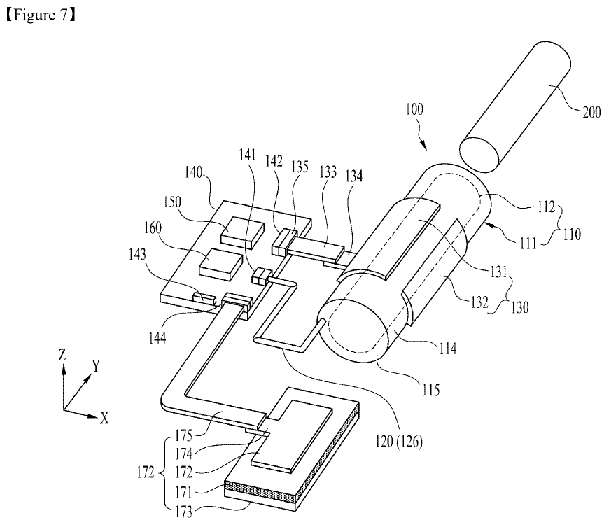

As shown in FIG. 7, the module 100 according to this embodiment also includes a mounting part 110, a heating part 120, and a first antenna 130 (along with elements 133, 134, 135). The structure of the mounting part 110, the heating part 120, and the first antenna 130 is the same as in the previously described embodiment, and detailed description thereof will be omitted.

The second antenna 170 may include a dielectric body 171 having a dielectric and disposed at a point separated from the mounting part 110, a second patch 172 having a conductor and fixed to the dielectric body 171, and a second ground 173 having a conductor and fixed to the dielectric body 171, the second ground 173 being disposed at a point separated from the second patch 172.

The dielectric body 171 may be made of the same material as the mounting body 111, or may be made of a different material than the mounting body 111. The second patch 172 and the second ground 173 may be disposed in the same plane in the space provided by the dielectric body 171, or may be fixed to the dielectric body 171 to face each other. FIG. 7 illustrates the latter case as an example.

The module 100 according to this embodiment may include a PCB 140 provided with circuitry for switching of the first antenna 130 and the second antenna 170, a controller 160 provided on the PCB to control the operation of the heating part 120, and a communicator 150 configured to supply current to the antennas 130 and 170.

The second patch 172 may be provided with a second feeding line 174. The second feeding line 174 may be connected to the communicator 150 via a second antenna wire 175. The PCB 140 may be provided with a fourth connector 144, and the second antenna wire 175 may be provided with a second antenna connector that is coupled to the fourth connector 144.

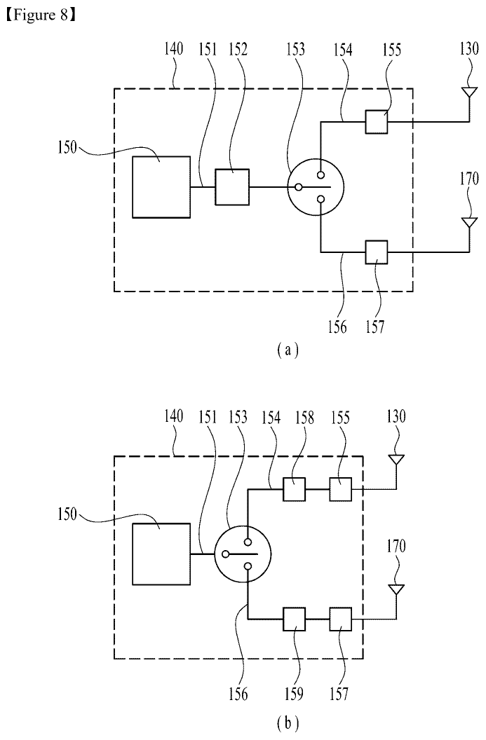

As shown in FIG. 8-(a), the PCB 140 may be provided with a first circuit 154 connecting the communicator 150 and the first antenna 130, a second circuit 156 connecting the communicator 150 and the second antenna 170, and a switch 153 configured to control the opening and closing of the two circuits 154 and 156.

The circuits 154 and 156 and switch 153 may be implemented using various structure. For instance, FIG. 8-(a) illustrates an exemplary case where the first circuit 154 and the second circuit 156 are selectively switched to one circuit (communicator circuit) 151, which is connected to the communicator 150, by way of the switch 153.

The communicator circuit 151 may have an amplifier (a low noise amplifier or a linear power amplifier) 152. The first circuit 154 may be provided with a first matching network 155 for impedance matching, and the second circuit 156 may be provided with a second matching network 157.

The embodiment of FIG. 8-(a) may be alternatively implemented using the structure of FIG. 8-(b). The embodiment of FIG. 8-(b) differs from the embodiment of FIG. 8-(a) in that the first circuit 154 is provided with a first amplifier 158 and the first matching network 155, and the second circuit 156 is provided with a second amplifier 159 and the second matching network 157.

For the communication and aerosol module 100 previously described, as shown in FIGS. 8-(a) and 8-(b), when the aerosol generating article 200 is not inserted into the accommodation space 112, the switch 153 operates to close the first circuit 154 (to connect the communicator to the first antenna) and opens the second circuit 156 (to disconnect the communicator from the second antenna). On the other hand, when the article 200 is inserted into the accommodation space 112, the switch 153 closes the second circuit 156 (to connect the communicator to the second antenna) and opens the first circuit 154 (to disconnect the communicator from the first antenna).

Thus, according to the present disclosure, an antenna to perform a wireless communication function may be selected among multiple antennas based on whether the aerosol generation function is executed, thereby minimizing the deterioration of the wireless communication function caused by a change in the dielectric permittivity of the mounting part 110.

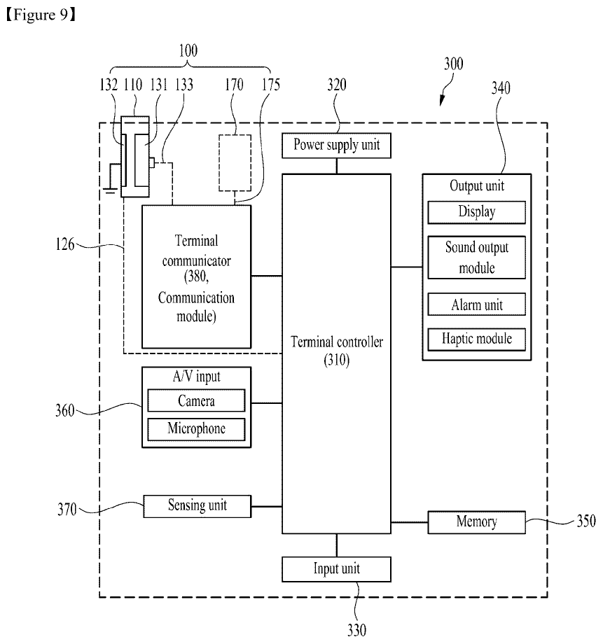

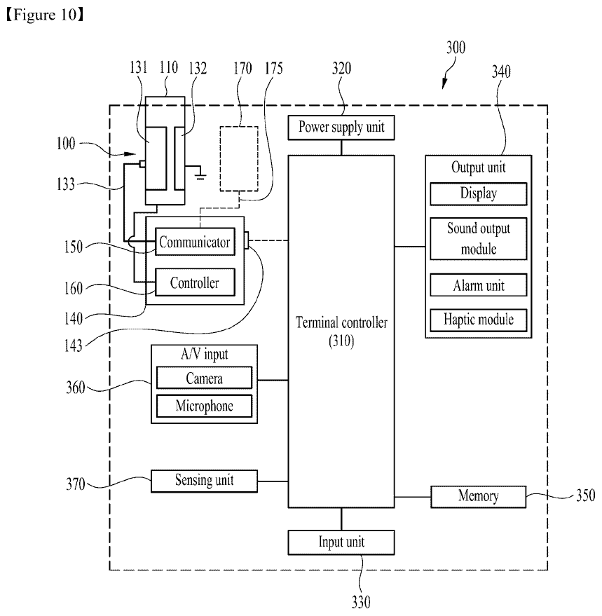

FIGS. 9 and 10 illustrate examples of a communication terminal 300 having the communication and aerosol module 100 described above.

The communication terminal 300 shown in FIG. 9 may include a terminal communicator 380, an audio/video (A/V) input 360, an input unit 330, a sensing unit 370, an output unit 340, a memory 350, a terminal controller 310 (e.g., one or more processors), and a power supply unit 320.

The terminal communicator 380 may include one or more modules or units (e.g., transmitters, receivers, transceivers, etc.) with appropriate circuitry that enable the communication terminal 300 to wirelessly communicate with other communication terminals. For example, the terminal communicator 380 may include a broadcast reception module, a mobile communication module, a wireless internet module, a short range communication module, and a location information module (e.g., GPS module).

The broadcast reception module receives broadcast signals and/or broadcast-related information from an external broadcast management server on a broadcast channel.

The broadcast channel may include a satellite channel and a terrestrial channel. The broadcast management server may represent a server that generates and transmits a broadcast signal and/or broadcast-related information, or a server that receives a pre-generated broadcast signal and/or broadcast-related information and transmits the same to the communication terminal. The broadcast signal may include a television broadcast signal, a radio broadcast signal, and a data broadcast signal, and may include even a combination of the television broadcast signal or radio broadcast signal with the data broadcast signal. The broadcast-related information may represent information related to a broadcast channel, a broadcast program, or a broadcast service provider.

The mobile communication module transmits and receives wireless signals to and from at least one of a base station, an external terminal, or a server over a mobile communication network. The wireless signals may contain various types of data according to transmission/reception of a voice call signal, a video call signal, or a text/multimedia message.

The wireless internet module is a module for wireless internet access. Wireless Internet technologies that may be employed may include wireless LAN (WLAN) (Wi-Fi), Wibro (wireless broadband), Wimax (World Interoperability for Microwave Access), and HSDPA (High Speed Downlink Packet Access).

The short range communication module refers to a module for short range communication. Short range communication technologies that may be employed may include Bluetooth, radio frequency identification (RFID), infrared data association (IrDA), ultra wideband (UWB), and ZigBee.

The location information module is a module configured to acquire the location of the mobile terminal. A representative example is a global positioning system (GPS) module.

The A/V input 360 is provided to input an audio signal or a video signal. The A/V input 360 may include a camera and a microphone. The camera processes image frames, such as still images or moving images, obtained by an image sensor in video call mode or photographing mode. The processed image frames may be displayed on the output unit 150, and may be stored in the memory 350 or transmitted to an external device via the terminal communicator 380.

The microphone receives external sound signals in the call mode, recording mode, speech recognition mode, or the like and processes the same into electrical voice data. In the call mode, the processed voice data may be converted and output in a form that can be transmitted to a mobile communication base station through the terminal communicator 380. Various noise reduction algorithms may be implemented in the microphone to remove noise generated in receiving external sound signals as input.

The input unit 330 generates input data for the user to control the operation of the terminal. The input unit 330 may be configured as a keypad, a dome switch, a touch pad (capacitive/resistive touch pad), a jog wheel, a jog switch, or the like.

The sensing unit 370 generates signals related to the position of the communication terminal 300, the presence or absence of user contact, the orientation of the communication terminal, the acceleration/deceleration of the communication terminal, and the like.

The output unit 340 is configured to generate an output related to visual, auditory, or tactile sensation. The output unit 340 may include a display, a sound output module, an alarm unit, and a haptic module.

The display displays (outputs) information processed by the communication terminal 300. For example, when the communication terminal 300 is in the call mode, it displays a user interface (UI) or graphical user interface (GUI) related to the call. When the communication terminal 300 is in the video call mode or the recording mode, it displays the recorded and/or received video or the UI or GUI.

The display may include at least one of a liquid crystal display (LCD), a thin film transistor-liquid crystal display (TFT LCD), an organic light-emitting diode (OLED), a flexible display, or a three-dimensional (3D) display.

The display may include a transparent or light-transmissive display (or transparent display). A representative example of the transparent display is a transparent OLED (TOLED).

The communication terminal 300 may include one, two or more displays. The multiple displays may be disposed on the same side of the communication terminal 300, or may be disposed on different sides.

In the case of a panel having a layered structure of the display and a touch sensor (configured to detect whether a user's body is touched) (hereinafter referred to as a “touch screen”), the display may function as an input device. The touch sensor may be configured in the form of a touch film, a touch sheet, a touch pad, or the like.

The touch sensor may be configured to convert a change in pressure applied to a particular portion of the display or a change in capacitance developed on a particular portion of the display into an electrical input signal. The touch sensor may be configured to detect not only the location and area of the touched portion, but also the pressure applied at the time of touch.

The sound output module may output audio data received from the terminal communicator 380 or stored in the memory 350 in the call mode, recording mode, speech recognition mode, broadcast reception mode, or the like. The sound output module may include a receiver, a speaker, and a buzzer.

The alarm unit outputs a signal for notification of the occurrence of an event in the communication terminal 300. Examples of events occurring in the communication terminal include receiving a call signal, receiving a message, inputting a key signal, and inputting a touch. The alarm unit may also output a signal for notification of the occurrence of an event in a form other than a video signal or an audio signal, such as vibration. Since the video signal or audio signal can be output through the display or the voice output module, the display and the voice output module may be categorized as part of the alarm unit.

The haptic module generates various tactile effects that can be felt by the user. A typical example of a tactile effect generated by the haptic module is vibration. In addition to vibration, the haptic module may generate a variety of other tactile effects, including effects caused by stimuli such as an array of pins moving perpendicularly to the contacting skin surface, blowing or sucking air through a blast or suction port, brush against the skin surface, contact with an electrode, or electrostatic force, and an effect caused by reproduction of a cold or hot sensation using an endothermic or heating element.

The haptic module may transmit the tactile effect through direct contact, and may also be implemented such that the user can feel the tactile effect through stimulation of muscle in fingers or arms.

The memory 350 (e.g., a non-transitory computer readable medium) may store programs for operation of the terminal controller 310, and may also temporarily store input/output data (e.g., phonebook, messages, still images, moving images, etc.). The memory 350 may store data related to various patterns of vibration and sound output when a touch input is provided on the touch screen.

The memory 350 may include a storage medium of at least one of the following types: flash memory type, hard disk type, multimedia card micro type, card type memory (e.g., SD or XD memory, etc.), random access memory (RAM), static random access memory (SRAM), read-only memory (ROM), electrically erasable programmable read-only memory (EEPROM), and programmable read-only memory (PROM), magnetic memory, magnetic disk, and optical disk.

The terminal controller 310 (which may be implemented using one or more processors) may be configured as a device or circuit to control the overall operation of the communication terminal 300. For example, it performs related control and processing for voice calls, data communications, video calls, and the like. The terminal controller 310 may include a multimedia module for multi-media playback. The multimedia module may be implemented within the terminal controller 310, or may be implemented separately from the terminal controller 310.

The terminal controller 310 may perform pattern recognition processing for recognizing handwriting input or drawing input provided on the touch screen as a character and an image, respectively.

The power supply unit 320 receives power from an external power source and an internal power source under the control of the terminal controller 310 to supply the power required for the operation of each component.

The communication and aerosol module 100 shown in FIGS. 1 to 6 may be provided in the communication terminal 300 of FIG. 9. In this case, the antennas 130 and 170 provided in the communication and aerosol module 100 may be connected to the terminal communicator 380 via the antenna wires 133 and 175, and the heating part 120 of the communication and aerosol module 100 may be connected to the terminal controller 310 via the heating part wire 126.

The embodiment of FIG. 10 illustrates the case where the communication and aerosol module 100 having the communicator 150 and the controller 160 is coupled to the communication terminal 300.

As described in FIGS. 1 and 7, the communicator 150 and controller 160 may be mounted on the PCB 140. In this case, the communicator 150 and controller 160 may be connected to the terminal controller 310 via the third connector 143 of the PCB.

The above-described communication and aerosol module and the structure and control method of a communication terminal having the module are illustrative of the present disclosure. Accordingly, the scope of the present disclosure should be defined by the appended claims, and all technical ideas within the scope equivalent thereto should be construed as being within the scope of the present disclosure.

1. A module for wireless communication and aerosol generation, comprising:
a mounting part comprising:
a mounting body shaped to define an accommodation space that is sized to receive an article having an aerosol generating material, wherein the mounting body comprises a dielectric; and
an inlet formed at an end of the mounting body to permit the article to be received by the accommodation space;
a heating part configured to heat the aerosol generating material when at least a portion of the article is positioned within the accommodation space; and
an antenna comprising:
a patch coupled to the mounting body and being located outside the accommodation space, wherein the patch comprises a conductor; and
a ground coupled to the mounting body, and being located outside the accommodation space and spaced at a distance from the patch, wherein the ground comprises a conductor.

2. The module of claim 1, wherein the mounting body is formed in a cylindrical shape,
wherein the patch and the ground are arranged to be spaced along a circumferential direction of the mounting body or spaced along a height direction of the mounting body.

3. The module of claim 1, wherein the mounting body is formed in a prismatic shape,
wherein the patch and the ground are arranged to be spaced along a perimeter direction of the mounting body or spaced along a height direction of the mounting body.

4. The module of claim 1, further comprising:
an extension body extending from the mounting body and being located outside the accommodation space, wherein the extension body comprises a dielectric and includes a shape of a flat plate, and
wherein the patch and the ground are coupled to the extension body.

5. The module of claim 1, further comprising:
an extension body extending from the mounting body and being located outside the accommodation space, wherein the extension body comprises a dielectric,
wherein one of the patch or the ground is coupled to the mounting body, and the other of the patch or the ground is coupled to the extension body.

6. The module of claim 1, further comprising:
a communication circuit configured to feed the patch; and
a controller configured to control operation of the heating part.

7. The module of claim 1, wherein the heating part comprises:
a coil provided inside the mounting body and surrounding at least a portion of the accommodation space to permit induction heating of a conductor disposed within the aerosol generating material.

8. The module of claim 1, wherein the heating part comprises:
a heater formed as a bar shape or as a plate shape, wherein the heater is coupled to the mounting body and is located within the accommodation space,
wherein, when at least a portion of the article is positioned within the accommodation space, the heater contacts the aerosol generating material through a bottom side of the article.

9. The module of claim 1, wherein the heating part comprises:
a heater formed as a pipe shape and is located within the accommodation space, wherein the heater surrounds a circumferential surface of at least a portion of the article that is positioned within the accommodation space.

10. A module for wireless communication and aerosol generation, comprising:
a mounting part comprising:
a mounting body shaped to define an accommodation space that is sized to receive an article having an aerosol generating material, wherein the mounting body comprises a dielectric; and
an inlet formed at an end of the mounting body to permit the article to be received by the accommodation space;
a heating part configured to heat the aerosol generating material when at least a portion of the article is positioned within the accommodation space; and
a first antenna comprising:
a first patch coupled to the mounting body and being located outside the accommodation space, wherein the first patch comprises a conductor;
a first ground coupled to the mounting body, and being located outside the accommodation space and spaced at a distance from the first patch, wherein the first ground comprises a conductor;
a second antenna comprising:
a dielectric body comprising a dielectric and being located at a distance from the mounting body;
a second patch comprising a conductor and being coupled to the dielectric body; and
a second ground comprising a conductor and being coupled to the dielectric body, the second ground being spaced at a distance from the second patch;
a communication circuit configured to control feeding of the first patch and the second patch;
a first circuit connecting the first patch and the communication circuit;
a second circuit connecting the second patch and the communication circuit; and
a switch configured to control opening and closing of the first circuit and the second circuit.

11. The module of claim 10, wherein, when at least a portion of the article is positioned within the accommodation space, the switch closes the second circuit and opens the first circuit.

12. The module of claim 11, wherein, when the article is not positioned within the accommodation space, the switch closes the first circuit and opens the second circuit.

13. The module of claim 10, wherein the mounting body is formed in a cylindrical shape,
wherein the first patch and the first ground are arranged to be spaced along a circumferential direction of the mounting body or spaced along a height direction of the mounting body.

14. The module of claim 10, further comprising:
an extension body extending from the mounting body and being located outside the accommodation space, wherein the extension body comprises a dielectric and includes a shape of a flat plate,
wherein the first patch and the first ground are coupled to the extension body.
